(19) United States
(12) Patent Application Publication
(10) Pub. No.: US 2004/0109586 A1
(43) Pub. Date: Jun. 10, 2004

(54) Shadowed image particle profiling and evaluation recorder

(76) Inventors: Scott Samson, Safety Harbor, FL (US); Lawrence Langebrake, Largo, FL (US); James Patten, Sarasota, FL (US); Chad Lembke, St. Petersburg, FL (US)

Correspondence Address: ALLEN, DYER, DOPPELT, MILBRATH & GILCHRIST, PA, P.O. BOX 3791, ORLANDO, FL, 32802-3791, US

(21) Appl. No.: 10/309,618

(22) Filed: Dec. 4, 2002

(51) Int. Cl. G06K 9/00

(52) U.S. Cl. 382/109

(57) ABSTRACT

The instrument of the instant invention provides for a fluidic plankton or other micro-particle analyzer that is capable of data reduction via a novel reduction circuit for better resolution in identification and quantification of the particles. By virtue of using line scan or similar cameras the instant system is capable of high resolution without as much interference as experienced with two-dimensional systems. The data reduction circuit also enables the microscopic material to be analyzed and recorded with better adaptability to current computer storage systems.

### GOVERNMENT SUPPORT

This invention was supported in part by funds from the US Government, Department of the Navy, Grant No. N 00014-96-1-5020, and the US Government may therefore have certain rights to this invention.

### FIELD OF THE INVENTION

This invention relates to oceanographic imaging systems for capturing the images of microscopic particles. More specifically, the invention is directed to a high-speed digital line scan system for detection and identification of microscopic particles in aqueous environments using a high-resolution sampling system.

### BACKGROUND OF THE INVENTION

Particulate matter in the ocean and other aqueous environments is derived from multiple sources. In the ocean, mostly “flake like” particles dominate what is commonly referred to as marine snow. Marine aggregate particles also result from biological activities such as abandoned houses from gelatinous feeders, residual food from inefficient grazers, feeding webs from pteropods, mucus, and fecal pellets. Hidden among the assortment of marine snow particles are living zooplankton, fish larvae, eggs, long phytoplankton chains and other related biologic material. The varied origin of marine particles results in a very diverse set of shapes, sizes geometries and optical properties. These properties are not only molded by the biological and physical properties of the ocean but can affect them as well. The importance of marine particles in chemical processes has also been shown. In order to unravel the intricacy of interaction between biological, chemical and physical processes in the ocean or other aqueous environment requires quantification, qualification and an understanding of distributions of marine particles as well as successful development of models of those environments. Many techniques for examining marine particles have been developed and experimented with over the past several decades. These techniques include both simple and complex methodologies most of which are plagued with distinct disadvantages ranging from being massively labor intensive to being intrinsically error prone. Methods that have been traditionally used include water bottle sampling, human visual observation, underwater photography, remote cameras, in situ large volume pumps, holographic imaging and sediment traps. In general, results from these methods show high variation in the concentration and type and number generally from 10 to 500 per liter in surface waters, while only a few per liter are found in deeper waters. These, of course, also vary between fresh and salt-water environments.

Methodologies providing the best results were those using non-intrusive techniques. Non-intrusive methodologies use acoustic and optical means to preserve fragile particle structure thereby reducing error in qualification and quantification. Of the more popular are those using structured light sheets to analyze particles. Instruments such as the Optical Plankton Counter, as disclosed by Herman et al, electronically measure the “magnitude” of cast shadows as particles pass through a 2 cm by 20 cm light sheet. Data is displayed in histogram form, showing distribution of particles in sampled water. Other much more sophisticated instruments such as the marine aggregate particle profiling and enumeration rover of Costello et al, when used in conjunction with image control and examination software, allow counting sizing, and some identification capabilities. The Costello et al system, also referred to as MAPPER, uses a thin structured laser light sheet to illuminate an examined “area” fixed in view of three high-resolution video cameras. Each camera has differing magnification to allow more thorough analysis of the captured image. Data is stored on videotape and analyzed by an automated software package. Although this is an excellent technique to reduce error in sample evaluation and reduces human review of particle images, analysis of large amounts of visual data must still be accomplished. In addition, the ability to perform on-site evaluations is limited since the data has to undergo a series of manipulations in the evaluation process. Furthermore, the technique does not lend itself to rapid analysis of large volumes of water due to limited camera resolution.

In studies of oceanic ecosystems, it is very important to know the temporal variations and spatial distributions of zooplankton, which constitute secondary production in such ecosystems. To date, the abundance of zooplankton has been monitored through sampling with a plankton net. In this approach, a conventional microscope is used to count and identify preserved plankton species. However, in this technique fragile particles such as jellyfish and some of the marine snow for example, are destroyed in the net collection or preservation; hence there is a need for in situ optical recording techniques for accurate representation. Previous in situ recording methods have included underwater photography and camera-based video systems.

In order to accurately determine biomass and particle counts, the system used must be capable of recording each particle only once. Unless the water velocity past the imaging system can be precisely controlled, particles recorded from two-dimensional (2-D) imaging arrays are either imaged multiple times or missed entirely, which introduces errors in the data. The resolution of a video camera is limited by the pixel count of its array. Analog tape recording or signal transfer systems further degrade the quality of images.

Both systems require an additional intermediate step of remotely digitizing the collected analog images before computer processing may be performed. Typically using reflective illumination techniques, these have the disadvantage of relatively low optical efficiency associated with collecting scattered light. High magnifications limit the depth of focus of these systems to a few millimeters. Holographic methods allow very high resolution imaging of a large volume of water and may be used to observe particle motion. However, holographic systems require bulky and expensive coherent laser illumination, precision optics, high-resolution single-use film, and a lab setup for reconstructing and imaging the light fields using conventional optics, such as microscopes.

Computer examination of images can assist in identification and sizing of particles of interest. For speed and simplicity of processing, it is beneficial to have a system that is capable of generating in-focus quality digital data directly readable by a computer. Additionally, the volume of data generated by imaging instruments makes it imperative for development of automated particle recognition algorithms. Otherwise, users will spend as much time manually identifying particle images as they would identifying organisms under a microscope. To this effect, particle and image recognition software has been developed for plankton, but reported analysis of field data using these packages has been limited.

Another photometric counting type of system is describe in U.S. Pat. No. 4,380,392 to Karabegov et al. In this system, a calibration particle is repeatedly moved across a sensing zone in order to calibrate the instrument. The threshold of sensitivity of the instrument is determined by repetitive sensing of the calibration particles and then this instrument is capable of analysis of other media. Of note in this patent is the use of conversion of light pulses into electric pulses which determine the quantity of particles in the test medium.

Manipulation of images obtained from two different directions is described in U.S. Pat. No. 5,975,702 to Pugh, Jr. et al. Here sensitivity is increased by enhancing vision is a highly scattering medium by generating images from two orthogonal polarizations, then subtracting the second value from the first to obtain the enhanced image. However, no real time data reduction to digital format for the purpose of cataloging size, number and variety of particles in a medium is possible here since the manipulation described here is for optimizing the image of single particles and the actual signals generated by the system serve to drive a motor to enhance a single image only.

Zemov et al, U. S. Pat. No. 6,262,761, is an example of a tethered underwater device for monitoring marine environments. Here the camera is looking at the macro characteristics and not the micro-environment and is transmitting real time images to a video screen. No data processing other than the real time images are obtained and data is stored on conventional tape, thus limiting resolution and the findings to large-scale types.

Hansen et al, U. S. Patent Publication No. 2002/0003625, describes detection in the micro environment with an optical system using fluorescence means. Because this system detects and discriminates in a 1-D flow direction, a means for aligning the particles is necessary. In addition, this system detects only scattering of fluorescence signals, and therefore, does not generate an image of the particle at all. Using the fluorescence technique reduces data but causes sensitivity problems since some particles do not have fluorescent properties and also when multiple particles are present simultaneously, error can occur. In addition, error can also occur when particles are not oriented in the flow direction and this aspect prohibits in situ work.

Butterworth et al, U. S. Pat. No. 6,130,956, discusses a system for sampling, concentrating, imaging, then storing and automatically recognizing particles it finds. This is a fairly generic system and the actual data manipulation for the purposes of an identification process are not disclosed. The captured images are used to trigger a fuzzy decision tree and generate warnings to close and open valves. The data is first recorded in analog format and then is converted to digital. Because of the number of peripheral devices necessary to process the data in this system, it is not capable of portable functioning, and indeed, water has to be pumped into the viewing chamber for it to operate as disclosed.

Another similar system to the Butterworth system is disclosed in U. S. Pat. No. 5,505,843 to Obuchi et al. Here, the system is generically described and comprises an optical/chemical measurement system with a decision tree which automatically makes a corrective action as a result of detection of certain particles or chemical species. Again, the computer system is described as being the information processing unit, but the specifics of how the computer actually handles the data are not given.

Computer recording of digital images with conversion to a compressed state is disclosed in Tafas et al, U.S. Pat. No. 6,320,174. Here a parallel microscope is used so that a plurality of imaging systems are arranged spatially, thus increasing overall imaging area. Because the number of imaging systems is increased, the number of samples or sampling area that may be observed at any given time may be increased. Each of the imaging systems appears to be conventional, but with allowance for a CMOS imaging array with on-chip image compression. This on-chip compression allows for reduction of the aggregate data rate that is collected by the computer. However, the images have to be reconstructed by decompression in order to evaluate the images for the features of interest.

Ikado et al, U.S. Pat. No. 6,313,943, describes an underwater microscope system in which a fairly small viewing chamber is used. Illumination is made with use of dark field (off-Axis) LEDs. Here, again, the samples are pumped to the viewing chamber. Ikado makes no provision for data digitalization or storage, with only display of images on a monitor being disclosed.

### SUMMARY OF THE INVENTION

It is therefore an object of the instant invention to provide a system for illumination, imaging, detection, identification and quantification of particulate matter in aqueous media.

It is a further object of the invention to provide a system for particle evaluation in a natural or man-made environment.

It is another object of the invention to provide a system for particle evaluation which has the capability of doing continuous imaging/recording of digital images directly without any analog recording steps.

It is a further object of the invention to provide a system for particle detection and evaluation which reduces the number of digital data levels during processing, thus reducing the data storage rate to the storage system and obviating the need for post-processing prior to evaluation.

It is another object of the invention to provide a system for modifying the order of image pixels in time or space, to simplify the generation of images on a computer or viewing system.

It is another object of the invention to provide a system for aqueous environment particle detection and evaluation that is portable and may be used to make in situ measurements in the environment without use of auxiliary pumping equipment.

It is another object of the invention to provide one, two, or multiple viewing directions to allow unambiguous determination of particles being imaged.

### BRIEF DESCRIPTION OF THE DRAWINGS

FIG. 1 is a schematic of the of the overall instrument of the instant invention.

FIG. 2 is a more detailed showing of one of the two optics systems of the instant device.

FIG. 3 shows an example of one image obtained by the instrument of the instant invention.

FIG. 4 represents another image obtained by the instrument of the instant invention.

FIG. 5 is a third set of images obtained by the instrument of the instant invention.

FIG. 6 is a fourth example of typical images obtained by the instrument of the instant invention. FIG. 7 is a schematic representation of the data reduction circuitry of the instant invention.

### DESCRIPTION OF THE PREFERRED EMBODIMENTS OF THE INVENTION

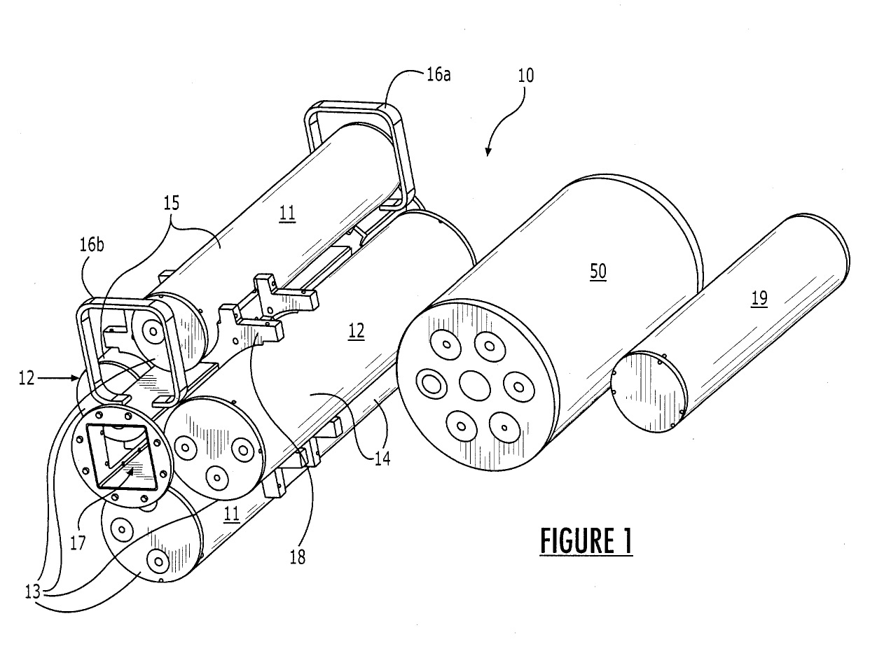

Referring to FIG. 1, the instrument 10 comprises two optical sections 11 and 12, which are located in housing 13 and are at substantially ninety degree angle with respect to each other. This duplication in the orthogonal cross flow axis allows imaging of each particle from two directions. With this geometry, the number of unidentifiable particles is reduced and it permits volumetric measurements to be made. Even though a ninety degree angle is depicted as the optimal angle, it is considered within the scope of the invention to orient the two optical systems at other angles with respect to each other to permit cross-sectional viewing of the sample chamber and the particles therein.

The housing 13 is made from any suitable material such as metals or engineering plastics as known to those of ordinary skill in the art. As shown, the housing 13 consists of six anodized aluminum pressure vessels with two 150 mm diameter cylindrical pressure vessels 14 containing the imaging system connected to two similar 100 mm diameter pressure vessels 15 containing laser or other appropriate optical source. The vessels 14 and 15 are fastened together with external clamps 18 and rods (not shown) defining a sample chamber 17. A specially designed optical interface member (not shown) serves to hold the vessels 14 and 15 in proper optical alignment with each other. As discussed earlier, this alignment is at a substantially ninety degree angle, but modifications of this angle are considered within the scope of the invention. A suitable power source 19 is also contained within the housing structure.

In addition to the four optical portions of the instrument and power source, the instant instrument also contains a digital data handling and storage system 51, housed in housing means 50. This electronics and software system allows for flexibility in configuration and operation and may also include optional real image or video screen viewing apparatus in addition to the capability of digitally storing information. In addition to data storage, the data handling and storage system 51 includes data synchronization electronics, a high-speed digital data storage mechanism and a Microsoft Windows™-based or equivalent processing and image-offload single board computer. These features are shown in FIG. 7. The entire instrument 10 is rigidly designed and is able to withstand rough handling without degradation in performance or optical alignment. Moreover, it is designed to prohibit ingress of water into the optical or electronic components.

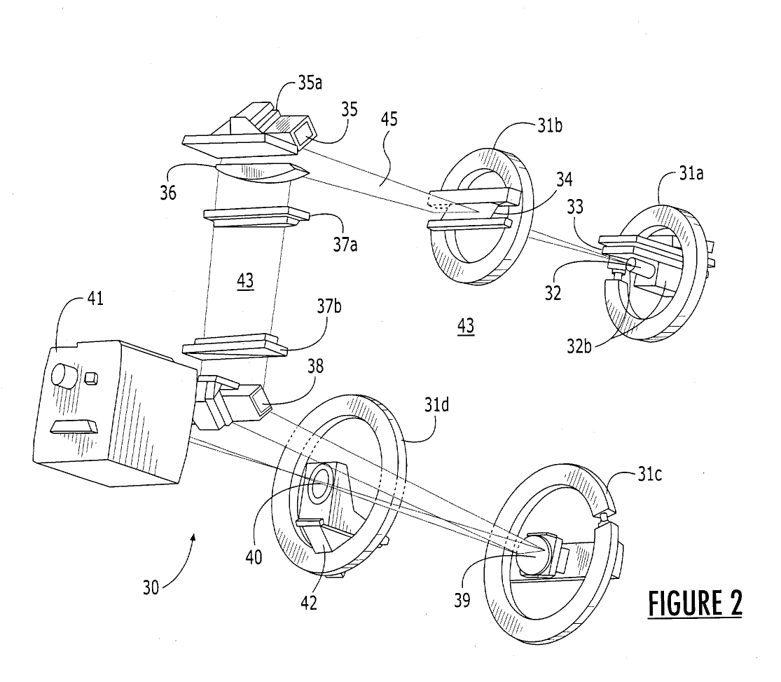

The optical component systems 30 are shown in FIG. 2. The optics design is a balanced compromise of optical path length, depth of field and percentage coverage of the sampling tube. As shown, the optical pathway defines a specific geometry, however this geometry is dependent of the size of the overall instrument and the length and sensitivity of the optical resolution desired, so any other geometry is considered within the scope of ordinary skill in the art. Each of these systems consists of securing members 31a, 31b, 31c and 31d. These members, here depicted as rings, serve to secure the optical components to the housing 13. Since the external housing 13 illustrated in FIG. 1 is shown as generally cylindrical, the securing members 31 are designed to accommodate this geometry, but it is considered within the scope of the invention that other housing and securing shapes may be used. The securing members 31 are also able to be adjusted within the housing 13 by movement of their assembly in directions normal to the linear axis of the housing member. In addition, precise optical adjustments may be made by means of fine adjustment screws located within the securing means 31 themselves.

Contained within securing member 31a is the optical source means 32. In a preferred embodiment, a 3 mW, 635 nm diode laser, with diverging optic 32b, available from Power Technology, Inc. is used. This laser is only representative and other coherent and noncoherent optical sources as known to those of ordinary skill in the art may be substituted. The light source 32 is adjustably affixed to the housing 13 and can be moved in pitch, yaw and translation directions by virtue of a tilting member 33 to enable precise modifications of the beam direction to be made. The light beam 45 generated by the source then is deflected off a mirror 35 or other suitable deflecting means. The light beam 45 is then directed to a focusing lens 36. In a preferred embodiment of the invention, the distance between the source 32 and this focusing lens 36 permits the light to be adjusted to a width of approximately 100 mm. The focusing lens 36 then collimates the beam into a sheet format. In the preferred embodiment a 280 mm focal length lens is used to form the beam into a 1×100 mm sheet format. Again, this may be modified by one of ordinary skill in the art depending on the optical properties desired. By the use of the mirror 35 the optical pathway is re-routed, without any loss of sensitivity enabling the total system to be of a more compact nature. The mirror 35 is adjustably affixed to the housing 13 and can be tilted by virtue of a tilting member 35a to enable small modifications of the tilt angle to be made, following the mirror 35 and collimating lens 36 the light path 45 then illuminates the sample chamber 43 area.

Before impinging on the routing mirror 35 and focusing lens 36, the light sheet may be optionally passed through a corrective lens 34. This lens serves to reduce the effect of mechanical vibration in the system on imaging performance by producing a thicker beam structure at the camera 41. In the preferred embodiment a plano-concave cylindrical lens is used, but any suitable lens which serves this purpose may be substituted.

The light sheet 45 passes through two sealed windows 37a and 37b which define its path through the sample chamber 43. These windows 37 are thick optical windows made of any suitable material, such as acrylic or glass, that permits light transmission with mininal interference. The windows 37 are of a suitable thickness so that they are able to withstand pressure and handling conditions in underwater environments without possibility of failure and are mounted within the housing 13 with O-rings that seal the optical portions to prevent any fluid incursion. After passing through the sample chamber 43, the light is then directed onto two additional turning mirrors 38 and 39 before passing through an image focusing lens 40.

Before entering the camera 41, the light sheet is passed through an imaging lens 40. This lens serves to sharply image particles within the sample chamber 43 onto the camera 41, with demagnification suitable to image substantially the entire sample chamber area onto the detecting portion of the camera. The lens is positioned coarsely and finely through the use of fixturing 13 and a translating lens mount 42. In the preferred embodiment a spherically-corrected doublet is used, but any suitable lens which serves the purpose of imaging with minimal aberrations may be substituted.

Because the method of imaging the objects in the sample chamber uses back-illumination, the system 10 of the instant invention has several advantages over the diffuse illumination typical of conventional diffuse illumination imaging schemes. The depth of field of this system is greater than that of conventional imaging schemes. Light passing through the sampling area and being imaged comes from within a narrow focused cone, thus providing a high f-number optical system. This high f-number provides a greater depth of field than that of a low f-system and back illumination maintains high light throughput. Conversely, with diffuse illumination, only a small percentage of the light created by the system would reach the active area of the camera, necessitating either more optical power or a lower f-number optical system. The semiconductor light source back-illumination system of the instant invention has the advantage of allowing lower power consumption, as less light is needed to illuminate the sample area.

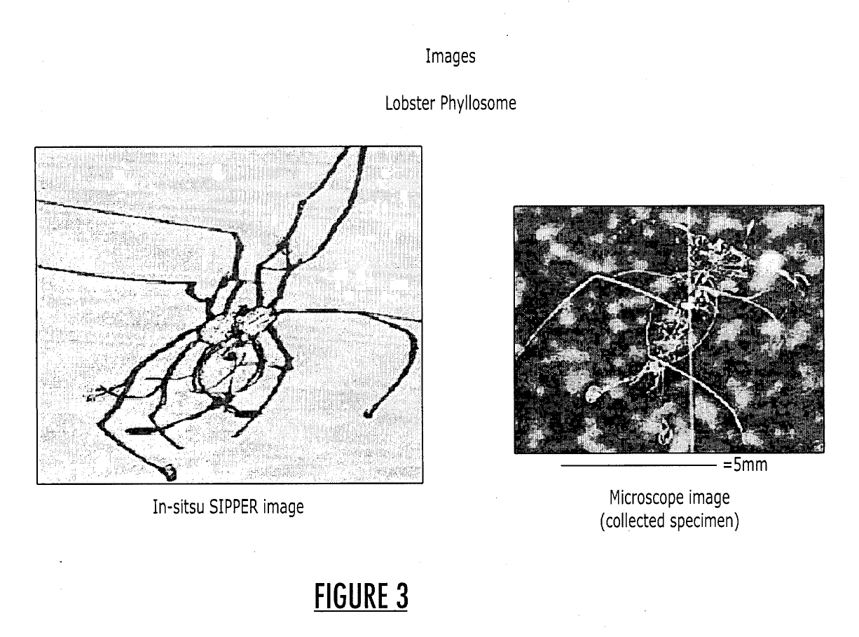

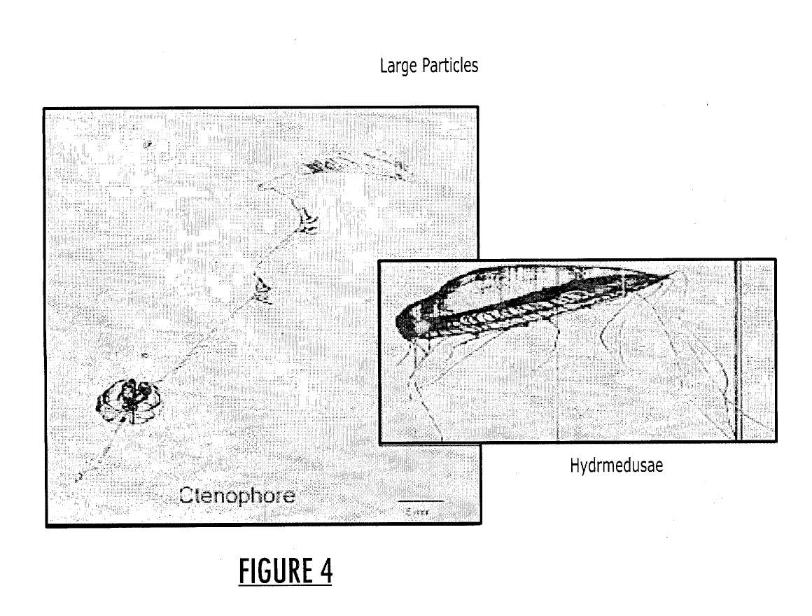

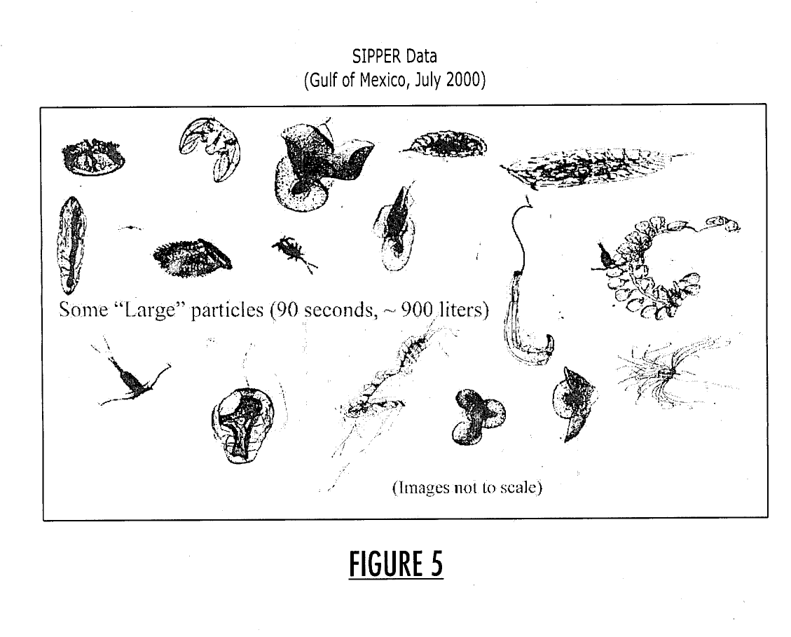

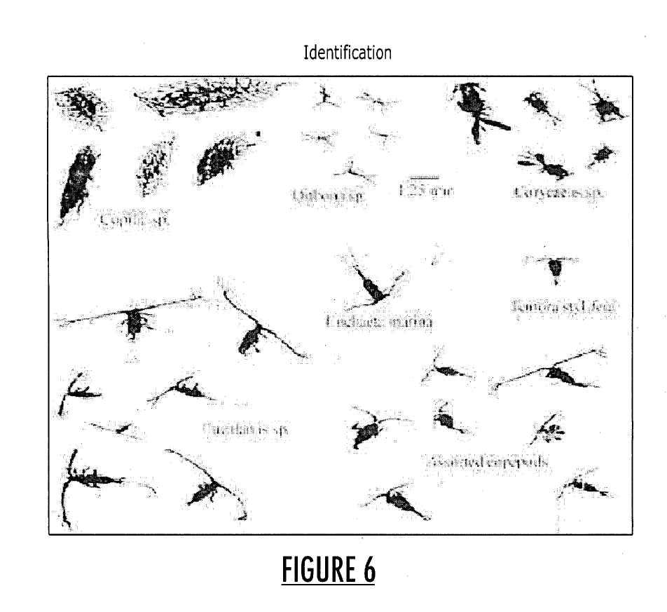

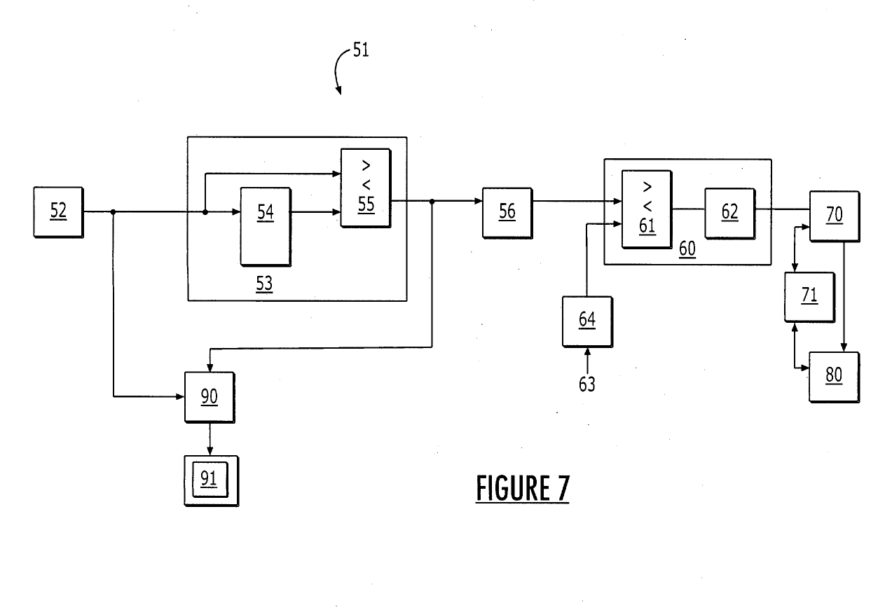

In the instant system 10, the resolution along the imaging line is fixed by the optics and number of camera pixels utilized. The resolution in the other direction is dependent on the water velocity and camera line scan rate. Because the particle flow past the underwater imaging system is unidirectional, the system 10, in its preferred embodiment, is configured with fast line scan cameras 41. Although other suitable camera or sensor systems may be used, line scan cameras are best suited for accurate particle counting in flowing applications when compared to other systems, including 2-dimensional array cameras. With the line scan camera, each section of the sampling volume 43 is imaged onto the imaging array once and only once, assuming non-turbulent flow characteristics are present. Conversely, a 2-D system offers the possibility of either missing particles or producing multiple images of them if they move more or less than a fixed distance between imaging frames. In the instant system, the independent duplication in the orthogonal cross flow axis permits imaging of each particle from two directions. This reduces the number of unidentifiable particles, and allows volumetric measurements to be made. Transient particle shadow images are captures in two directions to permit maximal characterization and 3-D reconstruction of sampled particles. Example of the images obtained by the instant invention are shown in FIGS. 3-6.

This imaging is facilitated by use of two high-speed line scan cameras, shown in FIG. 2 as camera 41. The two cameras may have the same resolution or may also be of differing resolutions. In the preferred embodiment a system containing two 4096 pixel cameras is used, such as the Dalsa Piranha™ series cameras. Each of these digital line scan cameras outputs approximately 90 million pixels per second with an 8-bit digital intensity resolution.

In order to produce accurately scaled images, the particle velocity is required. An additional instrument is used in-line to measure water velocity. Any suitable instrument capable of accurately measuring flow may be used, such as a GF-Signet paddlewheel flowmeter. Preferrably, mechanical-type flowmeters should be installed downstream of the imaging area to prevent disruption of the particles being imaged.

In order to reduce the data rate and post-processing requirements, a real-time threshold on the image data is performed within field programmable gate array (FPGA) based processing hardware. The threshold is set remotely by the user in a computer application, and is relayed to the hardware via an Ethernet data network link. Pixels darker than the threshold value are marked as black and those lighter are marked white. When the water contains no particles, all pixels are white.

The data network allows other parameters to be set, including data recording start and stop, and power down of inactive portions of the system to conserve energy. Information about the water flow rate is relayed back to the user via the data network to facilitate separately altering the flow of water through the instrument.

The thresholded image data from the two camera modules is combined into a synchronous parallel data stream within the data handling and storage system 51. Both cameras are synchronized so that each line contains information about an identical volume of water. The parallel data are buffered and sent to a Digital Data Recorder (DDR) or other analogous recorder, as known to one of ordinary skill in the art. The (DDR) stores clocked digital data onto simple or multiple hard disks, at up to 23 million bytes/second. In addition to recording the data, the user may also preview images in near real time via embedded software and the data network connection. In test mode, an image may be displayed on a multisync monitor.

In order to enable the data generated by the cameras 41, a specialized data handling and storage system 51 transforms the data into quantities that are compatible and convenient for the computer system. Because of the large amount of data generated by the pictorial imaging, prior art systems were incapable of being able to process the information generated by the camera systems. The very fact that the prior art is replete in describing the data reduction systems of the past is indicative of the problems encountered by prior imaging systems. The instant invention solves this problem by use of a novel data handling and storage system 51.

Referring now to FIG. 7, the data handling and storage system 51 has several functions. This circuit receives the digital camera data, converts the pixel information to a reduced-quantity digital stream, reformats the pixel locations to facilitate software reconstruction of images, and then digitally records the information for later evaluation. In order to do this effectively and quickly, the amount of information generated by the cameras is reduced using an electronic circuit as opposed to a software program.

As shown in FIG. 7, the data handling and storage system 51 has several functions. The receiving portion 52 of the circuitry receives the initial data output from the cameras 41 and conveys this information into the initial data reduction section 53. A monitoring circuit 54 is included to compare the instant pixel values to their average to compensate for any constant abnormalities in the illumination intensity. The data is then processed by a threshold comparison section 55 before being conveyed to a storage unit 56.

The receiving portion 52 of the data handling and storage system 51 receives the data sent by the cameras in a time-serialized fashion. The camera data is sent to the digital processing circuitry contained in the data handling and storage system 51 using serialized differential signaling, so as to avoid erroneous transmission due to common-mode electromagnetic noise, and to minimize the number of electronic wires. The serialization at the camera, and deserialization of the data handling and storage system may be performed by using the Camera Link or Flat Link™ (Texas Instruments) standard or any other suitable standard as known to those of skill in the art. Serialization is the process of sending multiple synchronous data bits per unit of time in a multiplexed fashion, such that each of the large number of data bits are each sent over a reduced number of conductors. Similarly, deserialization is the conversion of serialized data into its original synchronous parallel form. Cameras which support the Camera Link standard may be used in the instant system, or additional conversion hardware may be used to convert parallel output camera data into the serialized form. The digital processing circuitry contained in the data handling and storage system 51 has the appropriate circuitry 52 to receive the multiplexed or serialized information and deserialize this information prior to further processing. In operation, the receiving portion 52 circuitry consists of high-frequency termination resistors and a single or multiple integrated circuit. The output of this circuit represents a digital gray-scale representation of one or more pixels. In the preferred embodiment, the camera pixels are sent in a serialized fashion such that four pixels are received per unit of time or clock cycle.

The deserialized camera pixel information is then conveyed into the initial data reduction section 53. The monitoring circuitry 54 is included to store a time-averaged gray-scale value of each pixel. This circuit serves to periodically compare the current pixel value to a stored average pixel value. If the current pixel value is greater than the stored average value for the same pixel number, the pixel's stored average value is incremented. If the current pixel value is less than the average value for the same pixel number, the pixel's average value is decremented. This simple averaging scheme allows the hardware to track the average pixel values using minimal computation time (a few nanoseconds). The average pixel value may thus be read during half a clock cycle and written during the other half clock cycle. The average value for each pixel is stored and retrieved from a fast asynchronous static random access memory (SRAM). The time-averaged gray-scale value of each pixel thus is used to compensate for lighting nonuniformaties and optimize dynamic range of a reduced length binary code. The information is then conveyed into the threshold comparison section 55 of the data handling and storage system 51.

Using the average pixel value for each pixel as a reference, the gray-scale information is converted from 256 digital levels to 8. This allows the information to be represented by 3 bits per pixel instead of 8 bits per pixel. Here, data reduction is accomplished by determining the pixel value relative to the average pixel value and assigning a new pixel value based on that comparison. In the preferred embodiment, a pixel with a value greater than or equal to the pixel's average value is assigned a maximum binary value, and a zero-valued pixel, or one that falls below the threshold value, is assigned a minimum binary value (zero). The resulting reduced-bit binary value may be a linear or nonlinear representation of the pixel value versus the average value. Using the pixel's time-averaged value versus the original binary maximum code as the basis of the data reduction enables maximum usage of the number of bits available in the reduced-bit code, corrects for uneven lighting, and compensated for slowly-varying changes in lighting versus time due to fouling of the optical windows, for example.

The binary encoded information is then temporarily stored in a storage means 56, which in the preferred embodiment consists of a dual-port random access memory (DPRAM). This unit allows the control circuitry 53 to selectively store and retrieve specific pixels or groups of pixels at any given time, whether sequential or dissimilar in time order: The circuitry is optimal for reconfiguring the order of the pixels that are read into subsequent processing circuitry. This is especially useful when the instant invention is used with multi-tap cameras, where non-contiguous pixels are available from the cameras during each clock time cycle. In some multi-tap cameras, pixels are relayed in time, starting on the outsides of the linear array, followed by pixels nearer the center of the linear array. Finally, the center pixels are output. Because this gives a non-linear representation of the image, this format is inconvenient for reconstruction software or compression, since the pixels are not continguous. The DPRAM circuitry 56 allows the hardware to reconfigure the pixels to be read as a contiguous image. In the preferred embodiment, the write addresses and read addresses are on two separate pages in memory. The write addresses are written to their appropriate pixel numbers during each clock cycle and the read addresses are read as contiguous pixel numbers from the previously written pixel data storage page. The multiple-page memory access structure obviates the possibility that pixels from separate lines are overwritten before being read.

In addition to the above circuitry, the processing circuitry of the instant invention may also include an additional data reduction section 60 utilizing more thresholding 61 and data compression 62. In this thresholding step, the number of bits per pixel is reduced to one. Because, thresholding is often the initial step in image processing algorithms, and additionally reduces the data storage requirements, it is considered beneficial to compute this step in the hardware portion of the instrument as opposed to the software. In the preferred embodiment, the threshold is set as a fixed binary percentage of the reduced-bit binary of each pixel. The threshold value may be set by an external electronic signal 63, which is preferably operator-configurable over the existing data network, to allow for fine-tuning of the threshold if necessary.

Additional data reduction may also be accomplished through the use of widely known data compression technology, but this is considered an additional feature as opposed to the necessity of such technology in the prior art instruments. In a marine or other aqueous application, a run-length encoding scheme is convenient and realistic for hardware implementation. In a preferred embodiment, a suitable run-length encoding algorithm is implemented in a Field Programmable Gate Array (FPGA) integrated circuit. The run-length encoding can be implemented in a modest-capability FPGA (for example XILINX Spartan™ series) with a suitably designed state diagram. Alternately, the implementation could be performed in a different type of integrated circuit or plurality of circuits, including an application specific integrated circuit (ASIC) or other as known to those of ordinary skill in the art.

In addition, circuitry may be included into the data handling and storage system 51 to allow for the inclusion of additional information to be processed with the data stream 62. These consist of, for example, camera identification, end-of-line marks, water or fluid velocity information, and compression scheme being implemented. These forms of additional information may be used alternately or additionally to aid in instrument operation, provide performance data desired by the operator, or facilitate software reconstruction of images.

Further data manipulation in the data handling and storage system 51 includes a buffering portion 70 to modify the data stream into a format suitable for transferal to a digital storage unit 80. In the preferred embodiment of the invention, this is performed by using a first-in-first-out (FIFO) memory, which allows for dissimilar reading and writing rates for a short period of time. In alternate embodiments, a dual port memory with additional control circuitry may be substituted; these circuits are well known to those of ordinary skill in the art.

The preferred embodiment of the instant invention also includes circuitry 71 to determine if the digital data storage mechanism 80 is ready to accept data. When the data storage mechanism is determined to be ready, and the circuitry is activated by the operator or control circuit 71, the buffer memory 70 is then read and transmittal is made to the data storage mechanism 80. It should be noted that the circuitry 71 is capable of performing this handshaking operation at rates sufficient to support data transfer without any loss of data.

In addition, the processing circuitry 51 includes remotely located user capability to modify various parameters in the operation of the instrument. In the preferred embodiment, this control consists of an embedded microcontroller 64 allowing TCP/IP communication of a visual interface and virtual control buttons linked to a world-wide-web browser that is capable of viewing HTML (Hyper Text Markup Language) or another suitable data network language. One particular microcontroller suitable for this purpose is the SitePlayer™ Ethernet web server; other servers with digital input and output lines may be substituted, as readily known to those of ordinary skill in the art.

As mentioned before, additional circuitry is contained 90 in the data handling and storage system 51 to allow for attachment of one or several multi-synch video display units 91 to the instant instrument. This circuitry allows for generation of horizontal and vertical video synchronization signals to enable synchronization of the rate of the linescan camera to a video display unit. This circuitry produces an analog signal proportional to the corresponding line camera's digital pixel value, and its reduced form, with timing such that an image of the linescan appears as one or more lines simultaneously on the video display unit. This is accomplished by modification of the analog signal to produce an electrical voltage and current range suitable for the purpose of the display on the video unit. In addition, this modification may also be responsive to the signals to produce suitable automatic gain control in the video display unit. The circuitry 90 and video display unit 91 is optimally used in pre-field testing to determine and adjust optical components of the instant instrument, without the need for expensive frame-grabbers or additional computers. In addition, a video display enables the operator to obtain visual data that is of interest for a number of reasons.

Modification and variation can be made to the disclosed embodiments of the instant invention without departing from the scope of the invention as described. Those skilled in the art will appreciate that the applications of the present invention herein are varied, and that the invention is described in the preferred embodiment. Accordingly, additions and modifications can be made without departing from the principles of the invention. Particularly with respect to the claims it should be understood that changes may be made without departing from the essence of this invention. In this regard it is intended that such changes would still fall within the scope of the present invention. Therefore, this invention is not limited to the particular embodiments disclosed, but is intended to cover modifications within the spirit and scope of the present invention as defined in the appended claims.

What is claimed is:

1. An instrument for analyzing microscopic particles in a fluid comprising:
a. a chamber, said chamber being adapted to temporarily contain a sample;
b. a housing surrounding at least a portion of said sample chamber, said housing containing an optical imaging system responsive to variations of materials contained in said sample;
c. a data storage means, said data storage means being in circuit communication with said optical imaging system and being adapted to identify said variations in materials in said sample; and
d. a data manipulation means, said data manipulation means located between said optical imaging system and said data storage means, said data manipulation means serving to reduce the amount of data transferred from said optical imaging system to said data storage means.

2. The instrument of claim 1, wherein the data manipulation means comprises a data reduction circuit to electronically reduce the data input from the optical imaging system being conveyed to the data storage means.

3. The instrument of claim 1, wherein the optical imaging system comprises at least one source and at least one camera means.

4. The instrument of claim 3, wherein the optical imaging system comprises a plurality of camera means.

5. The instrument of claim 4, wherein the plurality of camera means define a plurality of similar optical members said members arranged at a fixed angle with respect to each other.

6. The instrument of claim 3, wherein the camera means comprises a line scan camera.

7. The instrument of claim 1, wherein the data storage means contains means to quantify and identify materials found in said sample.

8. The instrument of claim 1, wherein an additional visual viewing means is in circuit communication with said data storage means.

9. The instrument of claim 1, wherein a series of lenses is included in said optical imaging means.

10. A method of analyzing microscopic particles comprising:
a. providing a chamber, said chamber adapted to temporarily contain a sample;
b. providing a housing, said housing surrounding at least a portion of said sample, said housing containing an optical imaging system responsive to variations in materials contained in said sample;
c. measuring variations in optical properties of said sample with said optical imaging system;
d. conveying the measured variations to a data storage system via a data manipulations means which is adapted to reduce the quantity of data generated by said optical imaging system before storage in said data storage means.

11. The method of claim 10, wherein the data storage means additionally processes the data to provide quantitative and identification information about said sample.

12. The method of claim 10, wherein the sample is conveyed through said chamber in a continuous flow.

13. The method of claim 10, wherein the data is simultaneously viewed in a video monitor as is it passed to said data storage means.

14. The method of claim 10, wherein the optical imaging system is constantly controlled by a feedback mechanism with operator assistance capability.
